(19) United States
(12) Patent Application Publication
(10) Pub. No.: US 2022/0080536 A1
(43) Pub. Date: Mar. 17, 2022

(54) Device for welding, using a device, an insulating means body and a method for producing said device

(71) Applicant: Orbitalservice GmbH, Heimbuchenthal (DE)

(72) Inventor: Dirk KUNZE, Mespelbrunn (DE)

(73) Assignee: Orbitalservice GmbH, Heimbuchenthal (DE)

(21) Appl. No.: 17/424,581

(22) PCT Filed: Feb. 21, 2019
(86) PCT No.: PCT/DE2019/000042

§ 371 Date: Jul. 21, 2021

(30) Foreign Application Priority Data
Jan. 31, 2019 (DE) 10 2019 000 668.2

(51) Int. Cl. B23K 37/02; B23K 9/32

(52) U.S. Cl. CPC B23K 37/0217; B23K 37/0276; B23K 2101/06; B23K 9/32; B23K 37/0282

(57) ABSTRACT

An orbital welding device includes a receiving region into which a round tubular object to be welded can be inserted. The receiving region is designed in two parts with a folding joint for folding together a closing region, and includes a welding means which is rotated about the receiving region and by which the round tubular object is welded in a revolution using an arc welding. An electrically chargeable positive pole is provided on two surrounding outer plate means comprising an aluminum clamp shell housings, and an opposite electrically chargeable negative pole, is arranged on the receiving region with the rotating welding means. A respective insulating body is arranged between the positive pole and the negative pole. The insulating body includes a 3D-printed region, produced by a plastic powder laser sintering method, with one or more conducting means for welding gas and/or one or more conducting means for cooling water.

### CROSS-REFERENCE TO RELATED APPLICATION

This application is a national stage application, filed under 35 U.S.C. § 371, of International Patent Application No. PCT/DE2019/000042, filed on 2019 Feb. 21, which claims the benefit of German Patent Application No. 10 2019 000 668.2, filed 2019 Jan. 31.

### TECHNICAL FIELD

The disclosure relates to a device for welding in the orbital welding method, to a use of a device for welding in the orbital welding method, to an insulating means body, and to a method for producing a device for welding.

### BACKGROUND

It is known to use orbital welding tongs by means of closed welding tongs for welding in the orbital welding process by means of welding gas in an arc welding process for a tubular round object to be welded in a welding means rotating about a receiving region. This welding takes place under a high temperature load. In the arc, for example, a temperature of up to 6,000° C. prevails in the welding heads, as a result of which the load for the materials and components is very strong and thus requires good cooling and precise and clean gas supply to the welding head, which, however, is only insufficiently possible around the welding region by the currently used copper cooling lines. By means of the special folding/steering mechanism for folding up a closing region, a continuous and homogeneous cooling is not provided in the known method. In the prior art, it is attempted to keep heat away from the transmission even with further/other cooling channels in the head or milled-out brass plates which are hollow, since this always presents problems and mechanically blocks the heads with high heat input.

### SUMMARY

The aim of the disclosure is to provide a simple and reliably cooled device for orbital welding.

The aim is achieved by a device for welding in the orbital welding method by means of welding gas in an arc welding method, comprising a receiving region into which a tubular round object to be welded can be inserted, wherein the receiving region in particular constructed divided into two parts with a folding joint means for folding a closing region, a welding means rotating around the receiving region through which the tubular round object to be welded can be welded in a rounding by means of arc welding methods, wherein an electrically chargeable pole means, in particular positive pole means, is connected to two surrounding outer plate means comprising in particular metal, in particular aluminum side parts, in particular aluminum clamping shell housings, and an oppositely electrically chargeable pole means, in particular negative pole means, is arranged on the receiving region with the rotating welding means, wherein an electrically insulating, heat-stable insulating means body is arranged between the positive pole means and the negative pole means, wherein in one of the insulating means bodies, especially in two, a 3D-printed region, which is produced and/or integrated in particular by means of a 3D-printing method, in particular by means of a plastic powder laser sintering method, in particular having one or more line means for welding gas and/or one or more line means for cooling water, in particular by means of a plastic powder laser sintering method, in particular with one or more line means for welding gas and/or one or more line means for cooling water, in particular the insulating means body, is formed predominantly, in particular substantially completely, from 3D-printing.

By means of the device, including an advantageous construction, it is possible to guide cooling water three-dimensionally to the region, where heat removal is required, for example directly around mechanical elements for the precise operation of the welding device for cooling, in particular gearwheel axes, in order to prevent the expansion thereof in order to make the rotor guide more accurate, into which the hot electrode is screwed, in particular in the narrow body of a microhead for welding, in which no space is provided for conventional water lines. The head can be supplied in a targeted and required manner. It is possible to introduce/print the line means for cooling water and also gas channels uniformly into the construction. During the course of the water, in the prior art it is possible to cool with water from the outside only in the region of the welding tongs close to the handle, since no water can be brought through the joint of the tong region. In the prior art, homogeneous cooling is thus not possible without cold bridges in the welding head. The invention makes it possible to bring cooling all the way without having to take care of manufacturing limitations. The line means for the gas supply is also integrated and can be directly flowed into the welding chamber. As a result, there is no contamination of the gas by any abrasion of the gearwheels if the gas is flooded by this, which is important in rocket and reactor construction, and here too, in the case of possibly only gascooled welding heads, homogeneous cooling by cold welding gas and uniform inflow of the gas into the welding chamber can take place. As a result of the direct and stationary cooling on the welding tongs, an undesired thermal expansion of the insulating agent body with the working regions for the mechanics, in particular a toothed wheel mechanism, is ensured for the rotation of the welding head, so that the latter do not become jammed. Cooling lines in the welding device are integrated directly in the insulating agent body, so that reliable cooling up to the tong tips is possible and cold bridges or uneven temperature distribution are prevented, which can lead to stresses. The line means for the welding gas can also be brought closer to the arc-generating regions in the integrated form in the device, so that less gas is required. Mechanical is currently flooded with argon for arc activation in order to force the oxygen out by mechanical drive elements, in particular gear regions, approximately 6-301/min. In the prior art, the outer plate made of metal is partially hollowed out on the surface by means of milling operations, so that cooling water lines can be laid therein, and an insulation made of plastic arranged therebetween between the inner rotor and the outer plate is additionally cooled in a complicated manner by gas and/or water lines made of copper. The two-part head can also be cooled very homogeneously, in particular with integrated microbores.

It is advantageous if line means for cooling water are reaching up to end regions of the receiving regions, in particular higher than a height of a folding joint means, are integrated into the insulating means body.

It is advantageous if line means for welding gas are reaching up to end regions of the receiving regions, especially up to gas outlets in the receiving region are integrated in the insulating means body, especially for welding gas in the form of argon for activating the arc welding.

Thus the gas guiding can be carried out. Gas is directed out of the bottle cold through the pressure relief after the discharge and is simply guided into the welding chamber in the prior art. The gas can be used for cooling in the first course and then guided into the welding chamber. The gas is drawn into the welding chamber in a clean way through the pre-heated line guide, which is particularly important for the semiconductor or aerospace industry, in particular a weld seam of an Ariane rocket. The gas guiding does not touch any mechanical abrasion of the tooth. The line means for the welding gas can be guided through the mechanical actuating means.

It is advantageous if line means (8) for welding gas and/or line means (9) for cooling water are arranged one plane or a plurality of planes (13, 13′, 13″, 13′″) above each other in the insulating means body (4). The aim of the disclosure is to design XYZ-axes in a targeted, free manner, and to provide the designer with all possibilities which relate, for example, to radii, levels, circles, etc., to gears, etc., as a result of which, for example, accumulations in the gas or cooling water and insufficient flow are avoided.

It is advantageous if actuating means, in particular for the welding means, in particular mechanical drive means, in particular gearwheels and/or pin means for gearwheels and/or bearings for gearwheels, in particular ball bearings, are formed in an integrated manner in the insulating means body.

It is advantageous if each insulating means body has individually adapted, integrated line means and/or integrated actuating means.

It is advantageous if an insulating means body is formed comprising heat-stable plastic, in particular reinforced with glass fibres, in particular with glass-fibre-reinforced plastic with glass transition temperatures of up to 280° C., in particular glass-fibre-reinforced plastic with 30% glass content.

It is advantageous, if an insulating means body is formed comprising amorphous polymers with glass transition temperature corrections above 200° C., in particular adapted to nozzle temperatures at 3D pressure, in particular more than approximately 220° C., in particular bed and construction space at 3D pressure hotter than approximately 15° C., in particular hotter than 200° C. Filaments and printers which can print amorphous polymers are advantageously used with glass transition temperatures which are above 200° C., wherein these require very high nozzle temperatures, in particular more than 350° C., and the bed and the installation space are hotter than 120 or 200° C., as a result of which homogeneous printing, which is associated with high strengths of the insulating member body, is then possible.

It is advantageous if an insulating means body is formed comprising polymers such as PEEK and/or PPSU and/or PEI Ultem and/or PPS and/or PEKK. In the additive process area—for example with filaments or in the SLS process—an insulating member body is advantageously printed with polymers such as PEEK, PEI Ultem, PPS, PEKK 3D printed. It has well-isolated elements, heat-resistant and less post-work.

The object is also achieved by the Use of a device or welding in the orbital welding method by means of welding gas in an arc welding method, according to one of claims 1 to 9 in mini-fitting heads and/or micro-heads, comprising a receiving region into which a weldable, tubular round object can be inserted, wherein the receiving region is designed in particular divided into two parts by means of a folding joint means for folding a closing region, welding means rotatable around the receiving region, whereas the weldable, tubular round object is to be welded in one rounding by arc welding methods, wherein an electrically chargeable pole means, in particular positive pole means, is connected to two surrounding outer plate means in particular aluminum side parts, in particular aluminum clamping shell housings, and an oppositely chargeable pole means, in particular negative pole means, is arranged on the receiving region with the rotating welding means, wherein an electrically insulating, heat-stable insulating means body is arranged between the positive pole means and the negative pole means,

wherein in an insulating means body, in particular in two insulating means bodies, a 3D-printed region is integrated, which is produced and/or integrated in particular by means of a 3D-printing method, in particular by means of a plastic powder laser sintering method, in particular having one or more line means for welding gas and/or one or more line means for cooling water, in particular the insulating means body is formed predominantly, in particular substantially completely, by 3D-printing.

In the prior art, in particular in the so-called mini-fettling heads, there are space problems and efficient water cooling because an expansion coefficient of almost factor of 10 greater than steel prevails in this plastic. Due to the thermal expansion during welding, the stitch dimensions of the gear elements also change, so that increased wear of the gears can occur up to a standstill. This can be a striking of the teeth on the end face or simply sluggishness. Both cause weld defects or irregularities of the weld seam. By means of the device, reliable and reliable operation of the device is possible.

The object is also achieved by a Insulating means body for use in a device for welding, in particular according to one of claims 1 to 9, in an orbital welding method comprising a 3D-printed region, in particular with printed-in line means for cooling water and/or welding gas and/or printed actuating means, in particular with one or more 3D printed line means for welding gas and/or line means for cooling water, in particular the insulating means body is formed predominantly, in particular substantially completely, in the form of a 3D-printing, in particular line means for cooling water up to end regions of the receiving region, in particular up to a height of a folding joint means, into the insulating means body, wherein line means for welding gas, in particular up to end regions of the receiving region, in particular up to gas exits in the receiving region into the insulating means body, in particular for welding gas in the form of argon for arc activation, wherein line means for welding gas and/or line means for cooling water in a plane or in particular a plurality of planes are arranged one above the other in the insulating body, wherein actuating members are designed in particular for the welding means, in particular mechanical drive members, in particular gear wheels and/or pin means for toothed wheels and/or bearings for toothed wheels, in particular ball bearings, integrated into the insulating means body, wherein heat-stable plastic is comprised, in particular reinforced with glass-fibre reinforced plastic, in particular with glass-fibre-reinforced plastic with glass transition temperatures of up to 280° C., in particular glass-fibre-reinforced plastic with 30% glass content, in particular comprising amorphous polymers having glass transition temperatures above 200° C., in particular adapted to nozzle temperatures at 3D-printing, in particular more than 220° C., in particular bed and construction space at 3D printing hotter than 15° C., in particular hotter than 200° C., wherein in particular polymers such as PEEK and/or PPSU and/or PEI Ultem and/or PPS and/or PEKK are included.

The object is also achieved by a method for producing a device for welding in the orbital welding method by means of welding gas in an arc welding method, in particular according to one of claims 1 to 9, wherein a receiving region into which a tubular round object to be welded can be inserted, wherein the receiving region in particular divided into two parts by means of a folding hinge means for folding a closing region, into which an area surrounding the receiving region rotating welding means by means of which the tubular round object to be welded can be welded in a rounding by means of arc welding methods, wherein an electrically chargeable pole means, in particular positive pole means, is connected to two surrounding outer plate means in particular aluminum side parts, in particular aluminum clamping shell housings, and an oppositely chargeable pole means, in particular negative pole means, is arranged on the receiving region with the rotating welding means, wherein an electrically insulating, heat-stable insulating means body is arranged between the positive pole means and the negative pole means, wherein a 3D-printed region, which is produced and/or integrated in particular by means of a 3D printing method, in particular by means of a plastic powder laser sintering method, in particular with one or more line means for welding gas and/or one or more line means for cooling water, in particular with one or more line means for welding gas and/or one or more line means for cooling water, is integrated in a 3D printing method, in particular by means of a plastic powder laser sintering method, in particular the insulating agent body is produced predominantly, in particular substantially completely, in the 3D printing method.

Further features and advantages of the invention emerge from the claims and from the following description, in which exemplary embodiments of the subject matter of the invention are explained in more detail in connection with the drawings.

### BRIEF DESCRIPTION OF THE DRAWINGS

FIG. 1a is a perspective view of an apparatus for orbital welding.

FIG. 1b shows an insulating means body.

FIG. 1c is a sectional view of an insulating means body.

FIG. 2a is a sectional view of an insulating means body.

FIG. 2b is a sectional view of an insulating means body.

FIG. 2c is a sectional view of an insulating means body.

### DETAILED DESCRIPTION

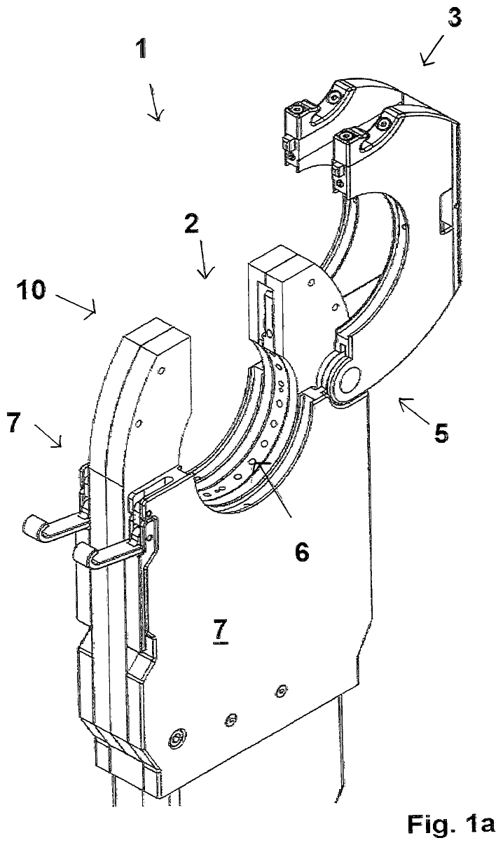

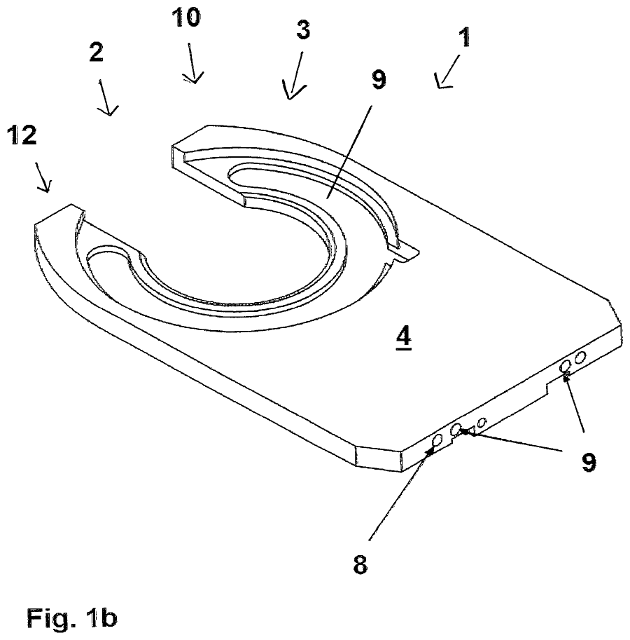

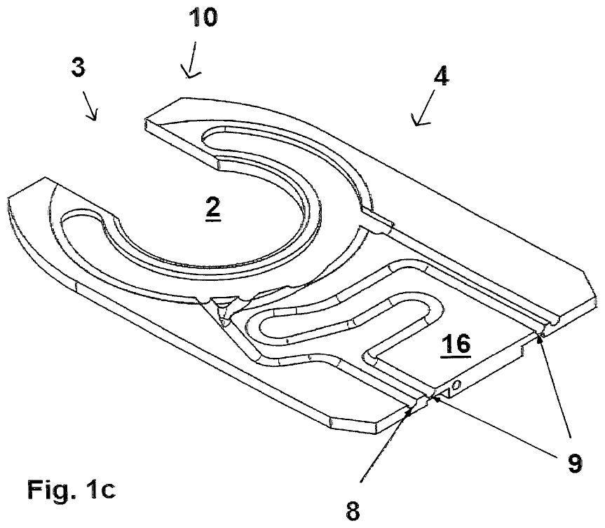

FIG. 1a shows a device 1 for welding in an orbital welding process by means of welding gas in an arc welding process, comprising a receiving region 2 into which a tubular round object to be welded can be inserted, wherein the receiving region 2 is constructed in particular in two parts with a folding joint means 5 for folding up a closing region 3, a welding means 6 which rotates around the receiving region 2 and through which the weldable, tubular round object can be welded in a rounding by means of arc welding methods, wherein a positive pole means comprises two surrounding outer plate means 7.

In particular metal, in particular aluminum side parts, in particular aluminum clamping-shell housings, and a negative pole means is arranged on the receiving region 2 with the rotating welding means, wherein an electrically insulating, heat stable insulating means body 4 is arranged in each case between negative pole means and positive pole means, wherein a 3D printed region is integrated by an 3D printing, in particular with one or more line means 8 for welding gas and/or one or more line means 9 for cooling water, in particular with one or more line means 8 for welding gas and/or one or more line means 9 for cooling water, in particular the insulating means body 4 is formed predominantly, in particular substantially completely, by 3D-printing. Two insulating body parts 4 are inserted exemplarily, they can be constructed in an advantageous and in a simple manner in different ways, as shown by way of example in FIGS. 1b, c, 2a-c.

FIG. 1b shows an insulating means body 4, produced by the 3D-printing method, can be inserted into an orbital welding tong, as shown in FIG. 1, with a receiving region 2 and, for example, with one or more line means 9 for cooling water, which can be partially recognised, which extend into end regions 12 of the line means, wherein line means 9 for cooling water are integrated into the insulating means body 4 as far as to end regions 10 of the receiving region 2, in particular up to a corresponding height of a folding joint means 5 up to correspondingly outer plate means 7 shown in FIG. 1.

FIG. 1c shows an insulating means body 4, the region of the sectional illustration, which is shown in FIG. 1b, being shown here in an opened sectional view. An exemplary line means 9 cools a body region 16 and another exemplary end portion 10.

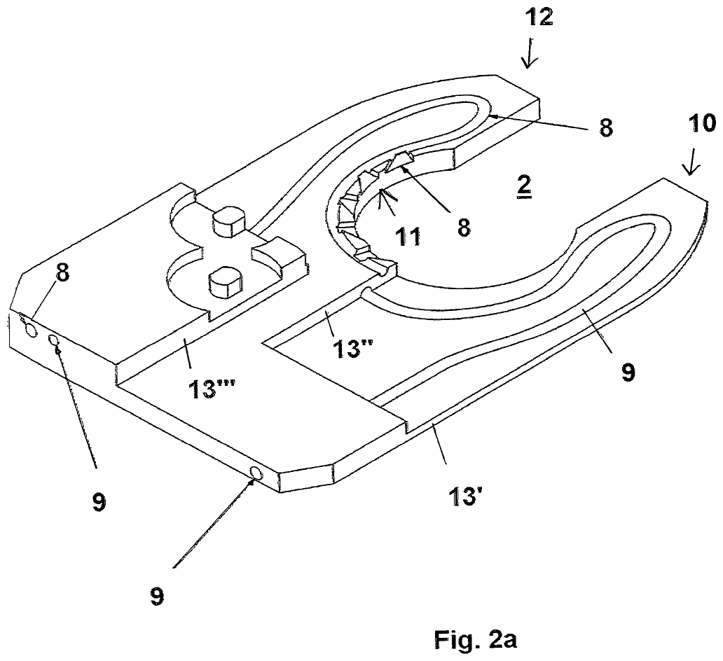

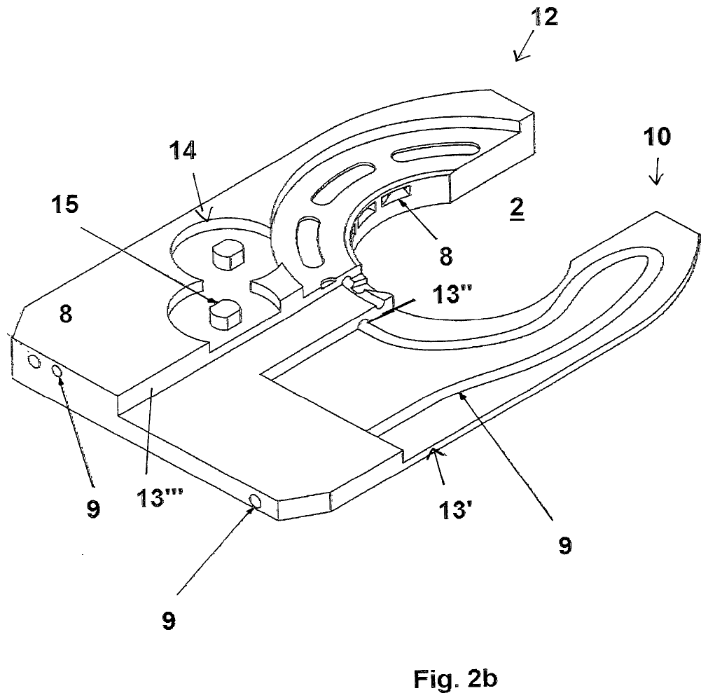

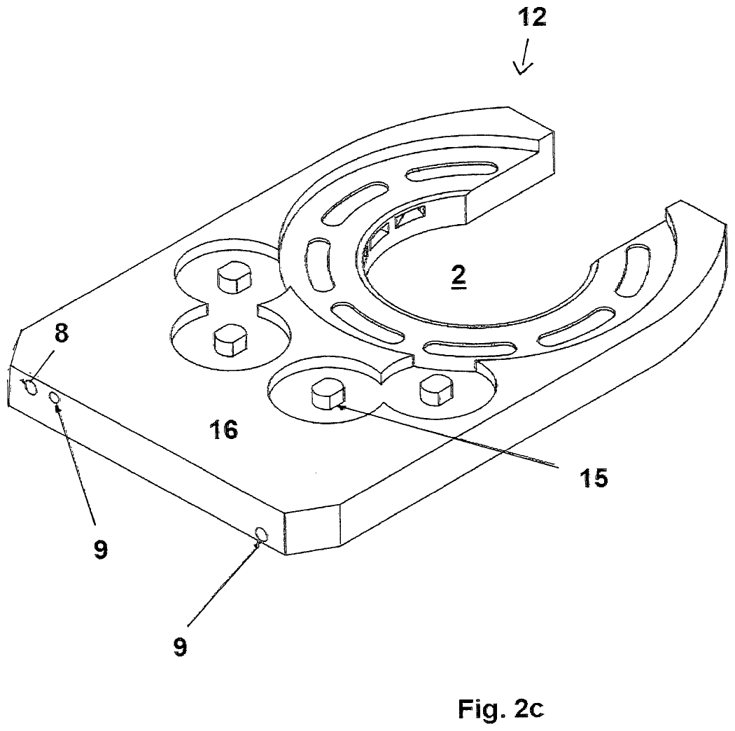

FIG. 2a shows an insulating means body, produced in 3D-printing, having a plurality of functional planes 13 which merge homogeneously, essentially in one piece, into one another, into which line means 8, 9 can be integrated one above the other and/or next to one another and thus can operate in a multifunctional manner and at the same time reliably up to the end regions 10, 12. Line means 8 for welding gas extend up to end regions 12 of the receiving region 2, in particular up to gas outlets 11 in the receiving region 2, in particular for welding gas in the form of argon for arc activation. Line means 8 for welding gas and/or line means 9 for cooling water can thus be arranged securely and in a simple manner in a plane or a plurality of planes 13 one above the other in the insulating means body 4.

Furthermore, as shown by way of example, in particular for avoiding different expansion lengths in the case of temperature loading and for a considerable saving of space, actuating means 14 can be formed in particular for the welding means, in particular mechanical drive means, in particular gear wheels and/or journal means 15 for gearwheels and/or bearings for gearwheels, in particular ball bearings, into the insulating means body 4.

FIG. 2b shows an insulating means body 4 shown opened with a plurality of functional planes 13′, 13″, 13′″, which can represent a further exemplary functional plane 13 on an insulating means body 4, as shown by way of example in FIG. 2a.

FIG. 2c shows an insulating means body 4 having a plurality of functional planes 13′, 13″, 13′″, for example on a lower functional plane 13′, such as, for example, in FIG. 2a and a subsequent plane 13′ shown here further closed, as shown in FIG. 2b. As a result of the planes, a variety of functions can be integrated into the insulating body, which are at the same time secure and are designed as far as outer regions, so that, for example, no cold bridges can be formed on sensitive mechanical elements.

### LIST OF REFERENCE SIGNS

1 Device for welding
2 Receiving region
3 Closing region
4 Insulating means body
5 Folding joint means
6 Welding means
7 Outer plate means
8 Line means for welding gas
9 Line means for cooling water
10 End region (for cooling water)
11 Gas outlet
12 End region (for welding gas)
13 plane
13′ lower level
13″ central plane
13′″ upper plane
14 Actuating means
15 Pin means
16 body region

1.-12. (canceled)

13. A device (2) for orbital arc welding, comprising
a receiving region (2) for receiving a tubular round object to be welded therein, the receiving region (2) being divided into two parts with a folding joint means (5) for folding a closing region (3);
a welding means (6) rotating around the receiving region (6) by which the tubular round object to be welded can be welded in a rounding by means of arc welding;
a positive pole means that is connected to two surrounding outer aluminum clamping shell housings (7);
a negative pole means that is arranged on the receiving region (2) with the rotating welding means,
wherein an electrically insulating, heat-stable insulating means body (4) is arranged between the positive pole means and the negative pole means,
wherein in one of the insulating means bodies (4) a 3D-printed region, which is produced and/or integrated in particular by a 3D printing method, having
one or more line means for welding gas and/or
one or more line means for cooling water.

14. The device according to claim 13,
wherein the line means (9) for cooling water are reaching up to end regions (10) of the receiving regions (2) higher than a height of the folding joint means (5).

15. The device according to claim 13,
wherein the line means (8) for welding gas are reaching up to gas outlets (11) in the receiving region (2) for carrying argon welding gas for activating the arc welding.

16. The device according to claim 13,
wherein the line means (8) for welding gas and/or the line means (9) for cooling water are arranged one plane or a plurality of planes (13, 13′, 13″, 13′″) above each other in the insulating means body (4).

17. The device according to claim 13,
wherein ball bearings are formed in an integrated manner in the insulating means body (4).

18. The device according to claim 13,
wherein each insulating means body (4) has individually adapted, integrated line means (8, 9) and/or integrated actuating means.

19. The device according to claim 13,
wherein the insulating means body (4) is made of glass-fibre-reinforced plastic with 30% glass content.

20. The device according to claim 13,
wherein the insulating means body (4) comprises amorphous polymers with glass transition temperature corrections above 200° C.

21. The device according to claim 13,
wherein the insulating means body (4) comprises one or more polymers selected from the group consisting of PEEK, PPSU, PEI Ultem, PPS, and PEKK.
